(19) United States
(12) Patent Application Publication
(10) Pub. No.: US 2006/0089886 A1
(43) Pub. Date: Apr. 27, 2006

(54) E-commerce business methodologies for supply and demand chain management

(76) Inventor: Anthony Wong, Old Westbury, NY (US)

Correspondence Address: OSTRAGER CHONG FLAHERTY & BROITMAN PC, 250 PARK AVENUE, SUITE 825, NEW YORK, NY, 10177, US

(21) Appl. No.: 11/260,776

(22) Filed: Oct. 27, 2005

Related U.S. Application Data
(60) Provisional application No. 60/622,380, filed on Oct. 27, 2004.

(51) Int. Cl. G06Q 30/00

(52) U.S. Cl. 705/26

(57) ABSTRACT

A system and method for providing integrated logistics services. In the system, an electronic trading facility, a logistics services group, a commercial-finance group; and an information-support group are organized and arranged to communicate and exchange information with each other over the Internet in order to provide logistics services to a customer.

### RELATED APPLICATION

This application claims priority from United States Provisional Application Ser. No. 60/622,380 filed on Oct. 27, 2004, the entire disclosure of which is incorporated herein by reference.

### FIELD OF INVENTION

This invention generally relates to a system and method for providing integrated logistics services.

### BACKGROUND OF INVENTION

The term electronic commerce (e-commerce) encompasses a wide range of tools and techniques used to conduct business in a paperless environment. E-commerce is having a significant impact on how organizations conduct business. The Internet allows firms to transfer information inexpensively and effectively throughout the world, making e-commerce a key contributor to supply chain integration.

With the new technology, B2B e-commerce helps company compete and win in an increasingly demanding marketplace, strengthen relationship, enhance operational efficiency, optimize sales and marketing, and leverage and extend existing systems. Integrating B2B e-commerce into company can improve operation efficiency, decrease costs, increase sales and facilitate communication with customers, partners and employees.

To take full advantage of the Internet and the potential of e-commerce, businesses need more than a web site. Not only they need to deliver the goods to customers quickly and securely, they also need to provide accurate accounting and shipping information in real time. This thus brings out the importance of logistics.

In recent years, effective logistics management has been recognized as a key element in improving both the profitability and the competitive performance of firms. It can help to reduce costs, improve services and enhance revenues simultaneously, as supplied chain activities have an enormous effect upon a company's performance basically due to the fact that it has an effect on up to 75% of a company's cost structure. High inventory levels also affect the competitiveness of wholesalers and retailers. Also, in international trade transaction, traditionally, buyers and suppliers must deal with different service providers such as freight forwarders, insurance companies, banks, and authorities such as the custom offices. This way of operation is complicated, inefficient, and prone to errors. Thus, there is an increasing consensus that logistics management and efficient integration along the supply chain will become an essential competitive tool for manufacturers and exporters in the world market.

### SUMMARY OF INVENTION

The present invention (hereafter, “Power Chain Network™” or “PCN™”) is a platform that provides integrated logistics services to clients that combines the advantages of B2B e-commerce, supply chain and demand chain management and many other value-added services. The present invention consists of numerous distinctive, yet interconnected, modular services grouped into the following categories:

1. electronic trading facilities (“eProcurement”);

2. logistics services (“eLogistics”);

3. commerce and financial (“commercial-financial”) services; and

4. information and supporting (“information-support”) services.

Traditionally, these services are provided by different entities, and trading partners had to deal with multiple parties to complete the transaction and take delivery of the merchandises. The present invention aims to eliminate the inefficiency of the entire procurement and fulfillment cycle, and provides a seamless, end-to-end, one-stop solution for clients to facilitate their order fulfillment with additional financial flexibility, by streamlining, integrating and consolidating the various processes within the cycle.

The present invention offers a one-stop solution for clients, simplifies and streamlines the processes, and eliminates the trouble and nuisance of dealing with multiple service providers and authorities. This present invention combines the best of both e-commerce and logistics management. It has an e-commerce front end for customers and manufacturers and a logistics management backend. The result is higher efficiency, lower operation cost, shorter order cycle, production cycle and lead time, better customer relationship management, more financial flexibility, optimized sales and marketing, and extending and leveraging existing systems.

The e-commerce front end consists of electronic trading facilities (eProcurement functions) such as electronic catalogues, virtual showroom, auctions, reverse auctions, order process, order tracking, online negotiation, online amendment, and online video conferencing. It also has a web-based electronic ordering platform designed for the apparel industry (“MV2002”) that simplifies the ordering process.

The logistics management (eLogistics) backend includes logistics modules such as warehousing and inventory management, insurance, inspection and quality assurance, picking and packing, distribution, freight forwarding. In addition, it also provides other value-added services (in commerce and finance) such as company incorporation, accounting, legal, secretarial and taxation services, EBPP and trade financing, and others. Information can be retrieved and is readily available through an information platform. It also provides supporting and maintenance services to clients. Information can be retrieved and is readily available through our information platform. It also provides supporting and maintenance services to clients.

Other objects, features, and advantages of the present invention will be apparent when the detailed description of the preferred embodiments of the invention are considered in conjunction with the drawings which should be construed in an illustrative and not limiting sense as follows:

### BRIEF DESCRIPTION OF DRAWINGS

FIG. 1 is a diagram of the present invention.

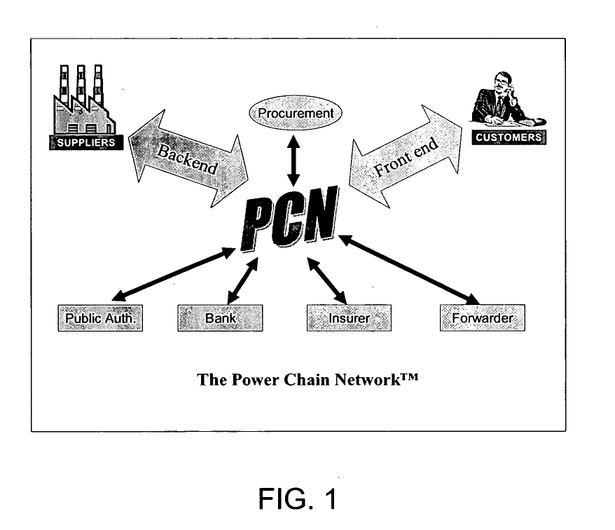

FIG. 2 is diagram showing the present invention in more detail.

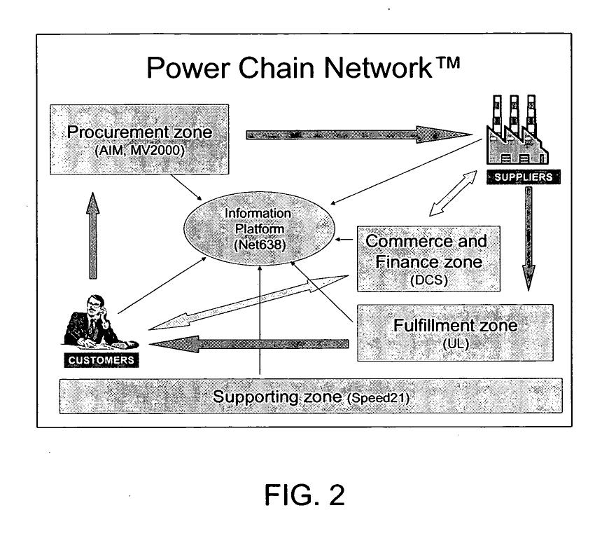

FIG. 3 is a diagram showing the flow of merchandise in the present invention.

FIG. 4 is a diagram showing the flow of documents in the present invention.

### DESCRIPTION OF INVENTION

The services of PCN™ are provided by a group of companies. Although each of the company provides unique services, the present invention coordinates their various activities to ensure faultless integration.

Aura International Management (“AIM”) is a vertical portal that provides e-commerce functionalities, such as on line catalogue, virtual showroom, auctions and reverse auctions. It operates Millennium Vision 2000 (“MV2002”), an apparel ordering platform adaptable to other merchandise.

Ultimate Logistics (“UL”) provides logistics management and freight forwarding services. It operates logistics centers in various cities around the world (e.g., Los Angeles, New York, Shanghai, Shenzhen, Hong Kong and Singapore). The logistics services comprise the planning and implementation of systems and processes to ensure the efficient flow of information, goods and materials to customers.

Dynamic Commerce Solution (“DCS”) provides value-added services such as company incorporation, accounting, legal, secretarial and taxation services, and electronic bill presentment and payment (“EBPP”) services. In addition, we partner with SGS to provide inspection/quality assurance services, team up with local insurance companies to provide insurance services and join force with Sterling Bank and Bank of Communication to provide financial services to our clients.

Speed21Business Network Limited (“Speed21”) is an e-business and networking solution provider. It offers a wide range of internet services such as web hosting and web design, electronic catalogues and content management, data warehousing and data mining, and customer relationship management.

Net638 is the information platform from which information related to the order can be retrieved. The website allows easy customization and integration of the system to meet clients' needs. The system monitors and tracks shipments at every stage in the delivery cycle, providing real-time visibility on shipment status, location and estimated delivery times via a peer-to-peer (“P2P”) network architecture.

The PCN™ groups its services of the trading cycle into four major categories: eProcurement; eLogistics Commerce and Finance; and Information and Supporting

Electronic Trading Facilities (eProcurement)

Electronic trading facilities are delivered by AIM and MV2002. AIM is a vertical portal catering to the apparel industry. It provides B2B e-commerce facilities to clients in the pre-order and procurement stages. The manufacturers, distributors and agents can showcase their products in an online electronic catalogue, or, for a more dynamic environment, a virtual showroom. They can also place their surplus on an online auction site, so that potential buyers can view and then bid for the surplus. On the other hand, in a reverse auction manner, buyers can upload their design with specific requirements, such as quality of material used, colors, and quantity, delivery and packaging terms to the information system. The request for quotation (“RFQ”) will be sent to all manufacturers who then submit their tenders. The job for the platform is to help customers to secure the best price and to select the best manufacturer. The functions available in AIM include: electronic catalogues, virtual showroom, auctions, reverse auctions, one-to-one negotiation, video conferencing and MV2002

MV2002 is the web-based apparel ordering platform. Buyers or retailers can login to the MV2002 platform of their distributors or agents so that they can place orders online. Although MV2002 is originally design for apparel industry, it can be easily modified for other industries. MV2002, situated between the suppliers and customers, drastically speeds up the handling time of order and increases the ability to handle huge number of orders. It also increases the flexibility of buyers as they can place orders around the clock. On the other hand, this system also saves cost as orders are kept in computer database which is more efficient and easier to distribute or share, whether with fellow employees or with other business entities. Errors and mistakes are reduced as human intervention is minimized. Data are transferred via EDI System so as to accelerate data transfer and improve reliability. In addition, if the information transfer between the buyers and the manufacturers is accelerated, the production cycle of products or goods will be faster. As a result, it increases the operation efficiency.

Also, MV2002 eases making changes on the order. In this system, order amendment can be done online. What can be changed depends on the stage of production. A customer only needs to login to the website and submit the changes. The data will be sent directly to the manufacturer within minutes. This way, changes can be made up to the latest possible moment and thus increase flexibility to response to the market taste. Table 1 below shows what can be changed at what stages.

TABLE 1

| | Stages | What can be changed? |
|---|---|---|
| 1 | Material Transporting | Material |
| 2 | Fabric Spreading and Cutting | Design |
| 3 | Garment Sewing | Color |
| 4 | Dying or Washing | Artwork |
| 5 | Artwork | None |
| 6 | Pressing & Folding | Label and ticket |
| 7 | Packaging | Destination |

MV2002 has an online video conferencing function, which allows the seller and buyer to communicate face to face. Before running this system, participating parties need to install a web camera. The system has both a face-to-face and multiple communications platforms. A client can simultaneously communicate with several parties directly. It is more effective than the traditional telephone communication and cost less as clients only need to pay the Internet connection fee rather than the international long distant telephone calls. Another benefit is the saving of travel time and cost as clients no longer need to travel long distant to meet with their counterparts. Furthermore, documents such as design and pricing information can be transferred through a secured extranet in a real time mode, so that the negotiation process becomes faster. eLogistics

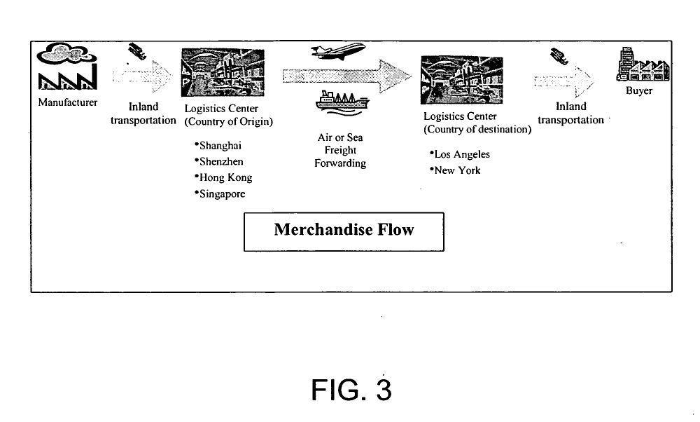

In the Power Chain Network™, UL is the logistics provider that engages in international and domestic logistic services to major retailers and importers in the United States. UL operates logistics centers around the world (e.g., Shanghai, Shenzhen, Hong Kong, Singapore, Los Angeles New York). As a logistics company, UL provides logistics services that includes warehousing and inventory management, sorting, consolidation, packing and repacking, custom declaration, and transportation. The locations of these logistics centers are strategically selected to facilitate the maximum throughput. The process of distribution of products from suppliers to the buyers is illustrated in FIG. 3.

All finished goods from manufacturers will first transfer to regional centralized distribution center (logistics centers) by inland transportation network. When cargo arrives warehouses, customers can have the option to use the inspection service provided by an inspection company (e.g., SGS) affiliated with UL, or inspect by themselves (or not inspect at all). Inspection at country of origin has a clear advantage problems can be detected at an early stage and thus prevent wasting time and money if the defective cargo is allowed to ship oversea. In addition, early inspection can make it possible for seller to activate the L/C or factor facilities at an earlier time.

After approval of the quality of finished goods, UL can make arrangements for customs declaration and clearance. If, for inventory control, there is a need to sort, consolidate and repack the shipment, UL provides such services, including generating UPC labels for transportation of the goods to the various distribution points and destinations by basic door-to-door custom-clearance delivery services that guarantee on time delivery to the destinations, all processes are according to specific requirements of customers.

For inventory replenishment, the UL can link up with the buyers' system to replenish their stock in a just-in-time manner. It can satisfy customers by maintaining sufficient quantities of products to meet expected demand. It tracks usage and vendor performance statistics to forecast demand. It also coordinates stock availability so that the right amount of the right product is available at the right time. It also automates the replenishment cycle to save time and money by reducing the expense of last minute reorders and lost sales opportunities when stock is unavailable. UL also helps a customer to maintain optimal stock levels, reduce inventory carrying costs, and help eliminate special or urgent reorder charges.

One other advantage of UL is its capability to generate RFID tags, which is growing in importance in international trade. UL can generate active RFID tags for shipment containers, and passive tags for the contents, helping with everything from preventing loss or theft of containers to complying with US security mandates. US customs requires shippers to send manifests of shipping contents 24 hours before sailing or risk encountering delays. Visibility into the container could expedite the process. By combining the passive tags on the pallets and boxes with active tags for the containers, it provides security, something the Homeland Security is looking for.

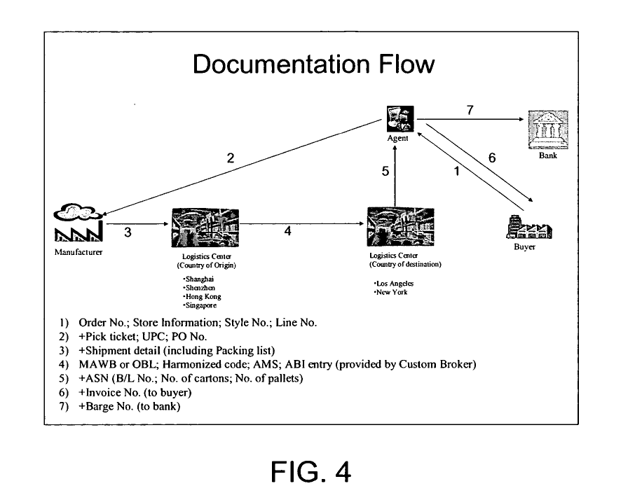

In international trade, flow of documentation is very important, as it affects the timely delivery of the cargos. The diagram in FIG. 4 illustrates the information flow of the entire process. All the documents are generated by UL at country of origin or at country of destination and transmitted by Electronic Data Interchange (EDI) to the appropriate parties. The advantage of EDI technology is that it is fast, secure, and facilitates activities such as custom clearance of shipments in advance of their arrival. In addition, each shipment is assigned a unique bar-coded airway bill enabling the customers to track shipment at key stages of its journey via the Internet. The present invention is also XML enabled.

A list of some of the services provided by UL is shown in TABLE 2 below:

TABLE 2

| Country of Origin | En Route | Country of Destination |
|---|---|---|
| Bar-coding | Trucking | Bar-coding |
| RFID | Ocean | RFID |
| Shipping | Air | Shipping |
| Receiving | Tracking | Receiving |
| Warehousing | ABI | Warehousing |
| Consolidation | | Consolidation |
| Inspection | | Inspection |
| Garment on Hangers | | Garment on Hangers |
| Sorting | | Sorting |
| Inventory control | | Inventory control |
| Inventory | | Inventory replenishment |
| replenishment | | Pick/Pack |
| Pick/Pack | | EDI/XML |
| EDI/XML | | AMS |
| AMS | | ASN |
| ASN | | Custom clearance |
| Custom clearance | | |

Commerce and Finance

Commerce and financial services are offered by Dynamic Commerce Solution (DCL). Clients can receive the following services: (1) commercial cervices, e.g., company incorporation in any state in the United States, accounting services, taxation services, legal services, secretarial services; (2) financial services, e.g., electronic bill presentment and payment or EBPP services, factoring, letter of credit, account receivable management, D/P (Documents Against Payment), D/A (Documents Against Acceptance), asset based lending, trust receipts, purchase order financing, import/export financing; (3) insurance services, e.g., cargo insurance, product liability insurance, insurance against nonpayment; and (4) inspection/quality assurance services, e.g., factory Inspection, production inspection, during production check, final random inspection, initial production check, pre-production check, container loading witnessing, country of origin verification, ISO9002 and SA8000.

A foreign firm can set up a subsidiary in the US easily by using the present invention's company incorporation services. It can set up a company on behalf of clients in any state in the U.S.A and provide the registration address so that the foreign firms need not actually have to set up a local office. It also provides secretarial services, accounting services, taxation services and legal services to clients.

In business transactions, with the advance of Internet technology, “paper” invoices have increasingly been shifted to electronic forms. Furthermore, electronic bill payments are becoming more popular. The present invention offers EBPP services so that the suppliers can send invoices, and the buyers can make payment via the present invention's private network

Operations of EBPP involve the following steps:

(1) Receipt notification, invoicing and document distribution, which includes sending an encrypted invoice via VPN with shipping and delivery information and confirmation of delivery.

(2) Buyer approval, which includes receipt of merchandise, matching purchase order with merchandise, making adjustments (if necessary), forwarding to account payable.

(3) Buyer payment and financing which includes choosing payment date and method of payment, transfer of payment, arranging trade finance (if necessary).

(4) Supplier collections and financing which includes matching payment to invoice, apply penalties (if any), posting to account, assigning receivables for financing (if necessary).

(5) Problem resolution, wherein any disputes and adjustments will be resolved.

A buyer has the choice of payment method. In international trade, payment can be made by letters of credit (L/C), D/P (Documents Against Payment) and D/A (Documents Against Acceptance). In addition to these payment methods, DCS also establishes an alternate payment method, “factoring”, that is more convenient, flexible and do not have the problems that L/C might bring upon. Keep in mind, all of these payment methods can be accomplished online.

Letters of Credit (L/C) are an integral part of international business. A L/C is a bank's promise to pay a seller on behalf of a buyer, providing the seller meets the terms and conditions stated in the credit. Banks act as intermediaries and have no actual contact with the goods bought and sold. The L/C serves as a guarantee that the buyer will receive the merchandise specified and that the seller will be paid in a timely manner. Each L/C transaction generally involves four parties: buyer, seller, issuing bank (which issues the L/C on behalf of the buyer) and advising bank (which authenticates the credit and manages the L/C process on behalf of the seller).

Documentary collection refers to the collection of a financial document (bill of exchange, cheque, promissory note, payment receipt) accompanied by commercial documents (invoice, bills of lading, insurance certificate, etc). The exporter forwards the documents to his banker for collection of the proceeds, and the documents are released to the importer only against one of the following terms of payment:

Document against payment (D/P)—In a D/P documentary collection, the documents are released to the buyer/importer upon payment. Thus, the buyer/importer has to pay outright from his/her own financial resources. Alternatively, the importer may arrange for trade financing from his/her own banker (in the form of trust receipt, overdraft, loan, etc).

Document against acceptance (D/A)—In the case of the D/A term, the buyer/importer does not have to pay immediately. The importer only does so after a certain period of time as originally agreed with the seller. When the documents are presented, the importer has to accept the tenor bill of exchange to signify his formal commitment to pay on the due date. Thus, on the due date, which may be 30 days, 60 days, or 90 days later, as originally agreed with the seller, the accepted tenor bill of exchange is presented to the buyer for payment.

Factoring is a way that exporters can draws cash from factor banks against sales and receivables. In the present invention, buyers can purchase overseas merchandise, based on Landed Duty Paid (LDP) quotation, without the need of L/C. LDP price quotation is easy for the buyer to compare the true cost. Overseas manufacturers then ship goods to pre-approved buyers without payment risk. The present invention can alleviate manufacturers' cash flow problem by providing account receivable financing for up to 80% when they ship their merchandise.

Advance Factoring enables a client to draw cash as soon as merchandise is shipped and invoiced to an approved buyer. Collection Factoring offers clients a nonborrowing credit, whereas Factoring Bank is responsible to collect payment so that once approved, the clients will be paid, whether the buyers pay or not. In Recourse Factoring, the factoring bank provides advances against sales and receivable without credit protection. This is for clients who feel credit protection is unnecessary as their customers are unquestionably creditworthy.

The advantage of factoring over other form of payment is plenty. L/C does not favor buyers as the issuing bank must pay under the terms of the L/C if the documents presented have no discrepancies. There is no mechanism to reverse the payment even the merchandise quality is unacceptable. For D/P and D/A, similar problem arise as the buyers must pay or guarantee to pay before the documents can be released to the buyers. By using factoring, buyers are better protected as they have the ability to charge back the manufacturers if the merchandises are not acceptable. On the other hand, manufacturers are protected if the quality of the goods they shipped matches the samples provided. They are guaranteed payments by the factor banks even if the buyers do not pay. It is the responsibility of the factor banks to collect the payment.

In addition to the online payment services provided by the present invention, it also provides other types of online financial facilities to clients so as to maximize their financial flexibility. Trust Receipt is one of the financing facilities available for imports. Bank makes an advance to the buyer to settle an import sight bill. The advance is generally for a certain period e.g. 60 days, 90 days, 120 days and the buyer is required to settle on the due date together with the interest at an agreed rate. Asset based lending is a secured business loan in which borrower pledge as collateral any assets used to conduct his/her own business. It is available to both importers and exporters. Purchase order financing can be used to pay suppliers, laborers, or other intermediaries for goods or services to generate additional sales. A company will need purchase order financing

Customers can also apply for cargo insurance, product liability insurance, and Insurance against nonpayment by filling the online application form, which is part of the web-based ordering system. They fill in the mode of transportation and the type of commodity and other information such as amount of insurance required, countries of origin and final destination, cities for loading and discharge, marks and number of cargo and the letter of credit condition. Such application details will be sent to an insurance company partnered with the present invention so as to get the instant certificate, which can be printed or downloaded easily. In addition, this certificate can also be transmitted via e-mail.

Inspection is the essential part of the supply chain. The procedure is to verify the quality and the adequacy of the product. In common usage, manufacturer and customer first agree on the standard of the products. Manufacturer's Quality Assurance (QA) people make sure the product conforms the agreed standard before exportation. Certainly, customers can inspect the products themselves on site or when the products arrived.

As another of the value-added services, the present invention may form an strategic alliance with an international branded testing, verification, inspection and quality assurance company (e.g., Société Générale de Surveillance or SGS) and have SGS be in charge of the inspection/quality assurance processes at the present invention's logistics centers. The present invention will adopt the production certification and production inspection processes of SGS. Customers have the option to use SGS or inspect by themselves.

For the production inspection, SGS can provide inspection service in different stages of manufacturing such as “During Production Check”, “Final Random Inspection”, “Initial Production Check”, “Pre-Production Check”, “Container Loading Witnessing”and “Country of Origin Verification”. The service is available both in the case when there is already an existing standard regulating the product or no existing standard.

Finished goods will be delivered from manufacturer to the central distribution center (logistics centers) by partner forwarders. The finished good will be checked by the inspector and approved by the international standard inspection company, SGS.

Information Platform and Supporting

Net638 is the information platform that adopts the Peer-to-Peer (P2P) networking technology. Net638 provides clients with information such as industrial news, and the usual communication channels like e-mail, forum, chat rooms and others. It also allows clients to track and trace their order, learn the status of the shipment, and others. These information are generated by the services providers during the transaction cycle. The platform will retrieve the most updated information from various services providers as per request by customers. By using P2P technology, maintaining vast accounts of outdated information in the system is avoided.

Peer-to-Peer (P2P) is a decentralized system that allows file sharing between different hosts. Every host is an equal participant, and there are no special facilitating or administrative roles. Peer-to-peer (P2P) networking eliminates the need for servers and allows all computers to communicate and share resources as equal. Many popular applications rely on P2P technology or variations thereof (e.g., ICQ, Napster). The basic premise behind peer-to-peer is that it's a networking technology that avoids a central hub. Users can download software that lets them directly connect to each other. There's no client-server, only client-to-client. Because the gateway to each client is through an ISP, it's in effect an intranet inside the public Internet. One person downloads a file-sharing application, then another, can share the files. Peer-to-peer has the advantages over traditional centralized server. It can save disk storage because it eliminates the needs to store duplicated data in the centralized database.

The Net638 website applies the idea of peer-to-peer. Information concerning a particular order resides in the database of the party that had completed its task. The directory of files location is centralized at Net638 server, which then answers search queries and brokering client connections. When customers want to track the information on their order, they browse the Net638 website, and submit queries. The request will be redirected to the database of the appropriate party, whether it is the Chinese manufacturers or the freight forwarder, and retrieve the most updated information.

One way the platform achieves its extensibility goals is through the use of XML for data exchange. Shared components in this platform can be packaged up as objects represented in XML format and transmitted over the network using popular protocols like XML-RPC and SOAP.

A unique twist in the platform is its automatic encryption of data being sent on the wire. This feature allows the platform to work much like a Virtual Private Network (VPN). The encryption occurs by default without user intervention on start up that can ensure that all data are secure.

Speed21is a pioneer e-Business enabler, enabling enterprises of all sizes, especially the traditional “bricks and mortar” ones, to elevate their competitive edge by exploiting the capacity of Internet. Speed21integrates the e-solutions and provides supporting services to the Power Chain Network™. It provides services such as website development, web hosting, Internet connectivity, customer relationship management, database management and content management.

What is claimed is:

1. A system for providing integrated logistics services, the system comprising:
an electronic trading facility;
a logistics services group;
a commercial-finance group; and
an information-support group,
wherein the electronic trading facility, logistics services group, commercial-finance group, and information-support group are adapted to co-act with each other over the Internet to provide logistics services to a customer.
